(19) United States
(12) Patent Application Publication
(10) Pub. No.: US 2005/0086118 A1
(43) Pub. Date: Apr. 21, 2005

(54) Information collection system

(76) Inventor: Yasumoto Murooka, Nara-shi Nara (JP)

Correspondence Address: Koda & Androlia, 2029 Century Park East, Suite 1140, Los Angeles, CA, 90067, US

(21) Appl. No.: 10/500,396

(22) PCT Filed: Jun. 13, 2002
(86) PCT No.: PCT/JP02/05927

(30) Foreign Application Priority Data
Jan. 16, 2002 (JP) 2002-7469

(51) Int. Cl. G06F 17/60

(52) U.S. Cl. 705/26

(57) ABSTRACT

An information collection system is provided, which comprises a means of providing a user with an access destination which is accessible through a terminal (1) of a user, a means of transmitting a question items (2) to the terminal (1) of the user when the user makes an access, and a means of receiving data (3) on the answer to the question items (2) transmitted from the terminal (1) of the user, and which is capable of acquiring various kinds of information from the user.

### TECHNICAL FIELD

This invention relates to a system which makes it possible to acquire various kinds of information from users who purchase or use goods or services from appropriate business providers of parking lots, video rental stores, restaurants and so on.

### BACKGROUND ART

There has been a way of soliciting people to purchase or use various types of goods or services by using direct mail and the like sent by E-mail or postal mail. However, because the solicitation mail is often received even by people who do not need information about the goods and the like, such solicitation mail results in a waste of paper resource or network resource. Moreover, such solicitation mail can annoy people who are not interested in the goods and the like and even worsen the image of the business providers, their goods, and the like.

Meanwhile, there have been parking lots constructed in numerous locations and drivers from all walks of life, regardless of age and sex, have been using the paring lots. However, there had been no attempts to conduct solicitation for encouraging the purchase of goods or the like to the prospective customers appropriately by collecting information from these drivers.

Furthermore, because parking fees must be paid to use parking lots, people who do not want to pay the parking fees tend to park their vehicle illegally. However, there have been no effective ways to reduce illegal parking except for strengthening crackdowns by police, and therefore the illegal parking situations have not readily improved.

Therefore, an object of the present invention is to provide an information collection system which can collect information to conduct solicitation appropriately for encouraging purchase or use of goods or services and also which can be utilized for reducing illegal parking.

### DISCLOSURE OF INVENTION

An information collection system of the present invention comprises a means of providing a user with an access destination which is accessible through a terminal of the user, a means of transmitting question items to the terminal of the user when the user makes an access, and a means of receiving answer data to the question items transmitted from the terminal of the user.

The means of transmitting the question items to the terminal of the user may transmit the question items which are appropriately selected based on the answer data that the user transmitted in the past.

The system may also comprise a means of storing user data in which information on offering benefits is recorded either unconditionaly or conditionally when the answer data to the question items is received from the user, so that the benefits for purchasing or using goods or services of appropriate business providers can be given to the user based on the recorded information on offering benefits.

The benefits which are given to the user based on the recorded information on offering benefits may pertain to use of parking lots.

The benefits which are given to the user based on the recorded information on offering benefits may pertain to purchase or use of goods or services that various kinds of business providers are offering.

The system may further comprise a means of transmitting authentication information to a portable terminal of the user by which the authentication information can be outputted in an appropriate form so that the outputted authentication information can be used at the time either when the user places an order or when the user makes a payment for purchasing or using goods or services.

### BRIEF DESCRIPTION OF DRAWINGS

FIG. 1 is a schematic view of an information collection system according to an embodiment of the present invention.

FIG. 2 is a schematic view of the information collection system according to the embodiment of the present invention showing how authentication information is transmitted to a portable terminal of a user.

FIG. 3 is a flow chart of the information collection system according to the embodiment of the present invention showing steps how the user receives benefits.

### BEST MODE FOR CARRYING OUT THE INVENTION

The embodiments of the present invention will become apparent from the following description read in conjunction with the accompanying drawings.

An information collection system of the present invention comprises a means of providing a user with an access destination which is accessible through a terminal 1 of the user, a means of transmitting question items 2 to the terminal 1 of the user when the user makes an access, and a means of receiving answer data 3 to the question items 2 transmitted from the terminal 1 of the user.

The information collection system also comprises a means of storing user data 4 in which information 5 on offering benefits is recorded either unconditionally or conditionally when the answer data 3 to the question items 2 is received from the user, so that the benefits for purchasing or using goods or services of appropriate business providers 6, 7, 8, can be given to the user based on the recorded information 5 on offering benefits.

The user is one of the general consuming public who, for example, purchases goods or receives services from the business provider 6, 7, 8.

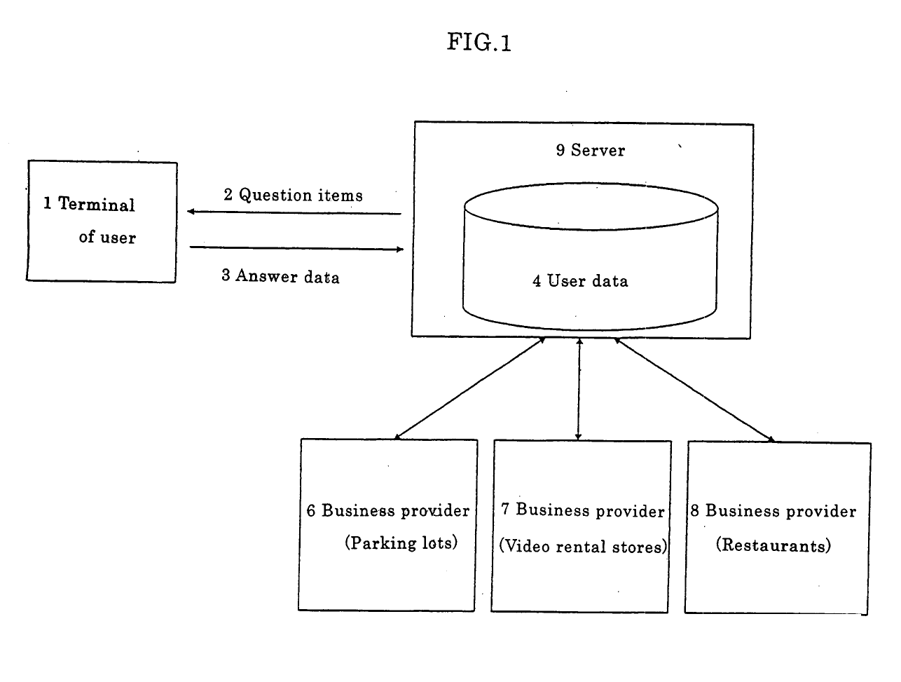

FIG. 1 is a schematic view showing a structure of the information collection system of the present invention. The system comprises a server 9 as the access destination. The server 9 functions as the means of transmitting the question items 2 to the terminal 1 of the user and the means of receiving the answer data 3 to the question items 2 transmitted from the terminal 1 of the user. The server 9 also handles other various processing. The server 9 is a computer which is accessible via communication lines such as the Internet. The server 9 may be a single computer or may be configured with plural computers connected each other. The server 9 is managed by an administrator of this system.

Appropriate kind of business providers can participate in the system administration by applying for it, and therefore the user can take advantage of the benefits for purchasing or using goods or services from these business providers. The business providers participating in the system administration may be a single business provider or plural business providers, or may be a single kind or plural kinds of business providers.

For example, the business provider 6 running parking lots in numerous locations participates in the system administration so that a user can take advantage of benefits such as discounts of the parking fees for the parking lots in numerous locations. Other business providers maybe of video rental stores 7, restaurants 8, and so on as well as the one of the parking lots. The administrator of this system itself can be one of the participating business providers.

An Internet connection service through a cellular phone such as i-mode (GMI of NTT DoCoMo Inc. can be used for the transmission of the question items 2, the reception of the answer data 3, and other communications between the server 9 and the terminal 1 of the user. Alternatively, the communications may be established through an automatic answering system with taped telephone voice or through a person (operator).

A cellular phone or a portable computer carried with a user may be used as the terminal 1 of the user. However, the terminal 1 does not have to be what the user carries with Computers which are set up in stores of the business providers 6, 7, 8, public phones placed in phone booths near the stores or in the restaurants, and the like can be used as the terminal 1. Personal computers which are set up in the user's house can be also used as the terminal 1.

When a portable terminal 1 is used, it is preferable that it is provided with a displaying means such as a liquid crystal display which can display plural lines of words in order to display the question items 2 transmitted from the server 9.

The terminal 1 of the user can be connected to the server 9 by appropriate connection methods such as a dial-up connection via Internet service providers, public phone lines, a private line connection, and so on.

In the system, the user is registered as a user member when the user accesses to the server 9 for the first time. The registration procedures such as the acceptance or the management of applications are handled by the server 9 or other appropriate computers connected to the server 9. At the time of the registration, the user inputs his/her name, address, age, sex, E-mail address, and so on.

Once the required items for the registration are inputted, the user is registered and provided with authentication information 10 either automatically by the server 9 or manually by a person. The user can use the authentication information 10 to identify himself/herself at the stores of the business providers 6,7,8. The authentication information 10 may be passwords consisting of several letters or may be electronic information which can be used by the terminal 1. Registration numbers and the authentication information 10 are given to the user by the Internet, postal mail, or the like.

The system may further comprise a means of transmitting the authentication information 10 to the portable terminal 1 of the user such as a cellular phone. In this case, the server 9 can function as the means of transmitting the authentication information 10. The authentication information 10 can be outputted in an appropriate form such as pictures or sounds by the portable terminal 1 of the user so that the outputted authentication information 10 can be used at the time when the user places an order for purchasing or using goods or services or when the user makes a payment.

A membership card to identify himself/herself as the registered member may be issued and sent to the user. The membership card may be any one of the cards in which information required for an access to the user data 4 stored in the server 9 is recorded, such as a magnetic card, an IC card, and a card with bar-cord.

The registration procedures are carried out at the time when the first question is provided or at other time separately from providing the question. The data received through the registration procedures is stored in the server 9 as the user data 4 with the answer data 3 which is described below. Once the user is registered, the user can receive question items 2 from the server 9 only by inputting passwords from the next time of using the system.

Moreover, the administrator of this system may provide payment methods for the purchase of goods or services of the business provider 6, 7, 8, at the time of the registration procedures of the user. A credit card is adopted as one of the payment methods. At the time of the registration procedures, both receiving application for a credit card and issuing the credit card are conducted simultaneously Therefore, the number of the credit card members increases, and the credit card providers can make great profits. The credit card can be also used as the membership card.

The administrator of this system gives the benefits for purchasing the goods or the services of the business providers 6, 7, 8, to the user based on the information 5 on offering benefits which is stored in the user data 4. For example, the user who answered the question items 2 can take advantage of benefits such as discount coupons, exchange coupons for goods, or free coupons in return for the purchase of goods or services of all participating business providers 6, 7, 8, depending on the number of times of answering the question items. Moreover, the user data 4 may be accessible through the terminal 1 of the business provider 6, 7, 8, so that the business providers 6, 7, 8, can offer benefits respectively to the user based on the information 5 on offering benefits.

The benefits such as discount coupons may be transmitted in a form of an electronic document by E-mail or sent by postal mail to users who meet the requirements for the benefits so that the users can take advantage of the benefits. Alternatively, the users may show their membership card to the business providers 6, 7, 8, so that the business providers 6, 7, 8, can access to the user data 4 to check if the users meet the requirements for the benefits, and if so the users can take advantage of the benefits.

The server 9 comprises the means of storing the user data 4. When the server 9 receives the answer data 3 to the question items 2 from the user, the information 5 on offering benefits is recorded (added, renewed, partially or totally deleted, and so on) in the user data 4. The user data 4 may include information about how many times the user has transmitted the answer data 3 to the question items 2 and the details of the goods or services that the user purchased (in case of parking lots, information about how long and how many times the user has used the parking lot, or the like).

The information 5 on offering benefits may include, for example, discount rate from the set price for the purchase or use of the goods or services of the business providers 6, 7, 8. The business providers 6, 7, 8, who offers the benefits can use the information 5 indicating the discount rate to calculate the discounted price and to charge for the purchase of the goods or services.

The information 5 on offering benefits can be recorded in the user data 4 under such conditions as the discount rate can be changed depending on how many times the user has transmitted the answer data 3, how many times the user has accessed to the website and so on.

Users become willing to purchase the goods or services from the business providers 6, 7, 8, participating in this system for the purpose of receiving the benefits. Therefore, the business providers 6, 7, 8, can make big profits.

The users can take advantage of the benefits by receiving a discount for the purchase or use of the goods or services of the business provider 6, 7, 8, or by receiving an extension of using time of the services. The payment may be made by credit cards, withdrawal from bank accounts, electronic money, or other electronic payment methods.

When cellular phones are used as the terminal 1, in addition to using the automatic answering system with taped voice, the users can also use Internet services such as i-mode so that the users can take the payment procedures visually through the screen display of the portable terminal. Further, the users can use ETC (Electronic Toll Collection System) which is a system to make a payment for a toll by wireless communications between an antenna placed on a road and a device equipped on a car

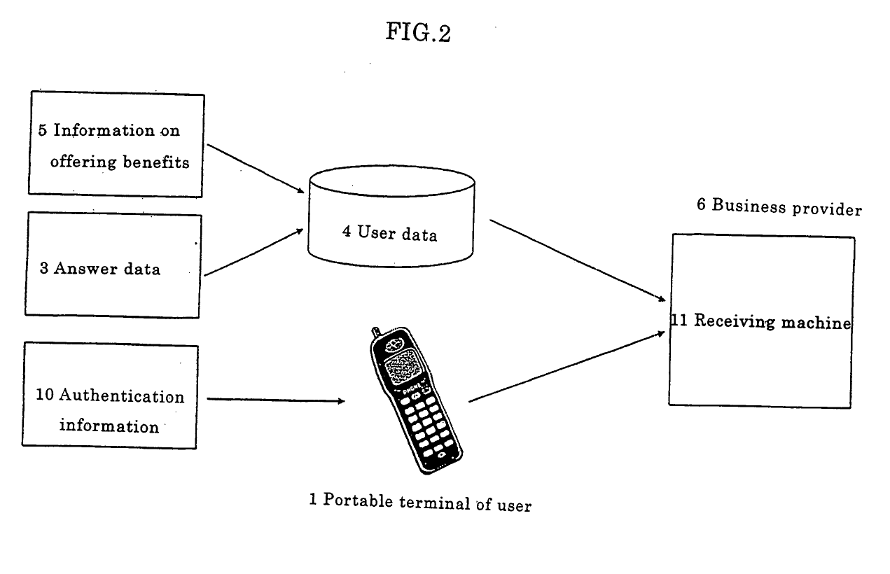

In case that the above-mentioned authentication information 10 is transmitted to the portable terminal 1 such as a cellular phone and the like of the user, the authentication information 10 can be, for example, a two-dimensional bar-code which is displayed on the screen of the portable terminal 1. As shown in FIG. 2, there is a receiving machine 11 equipped with a scanner for the two-dimensional bar-code placed in the stores of the business provider 6, 7, 8, participating in the system or in the places where they provide services. The receiving machine 11 can be used to receive an order for purchasing or using goods or services and make an arrangement for a payment or the like. The receiving machine 11 can scan the authentication information 10 displayed on the screen of the portable terminal 1 of the user so that it can verify the user and withdraw the amount from the user's bank account.

If the terminal 1 is equipped with GPS (Global Positioning System), the GPS can be used to identify the location of the user and therefore the payment can be safely settled.

Information about apparatus placed in the stores of the business provider 6, 7, 8, participating in the system and information 5 about the sales or the like are made to be transmitted to the server 9 as needed so that the administrator of this system can intensively manage the information. For example, the information about breakdowns of vehicle lock apparatus or fee collection apparatus placed in parking lots is transmitted to the server 950 that a repairman can be sent to the parking lot in case of breakdowns.

The administrator of this system can obtain various answer data 3 to the question items 2 from the user. The user data 4 including the answers to the question items 2 obtained from the user can be stored in a data base and used for a variety of purposes. For example, the user data 4 is used to analyze the interests and preferences of the user and make a list of addresses to which the direct mail relating to purchase or use of goods or services is to be sent.

The administrator of this system can sell the answer data 3 or information obtained by modifying the answer data 3 to someone (sponsors) seeking for them. The sponsors may include various business providers, business agents, and the like. The administrator of this system can transmit advertisement data regarding goods or services to the user with the question items 2. The advertisement data is outputted in appropriate forms such as pictures and sounds by the terminal 1 of the user. This enables the administrator of this system to make a profit by charging the sponsors for advertisement fees.

All or part of the profit obtained from selling the answer data 3 or charging for the advertisements are paid out to the business providers 6, 7, 8, participating in the system so that the business providers 6, 7, 8, can provide their goods or services for free or at low prices.

The question items 2 can be made as the sponsors would like them or can be provided by the sponsors themselves.

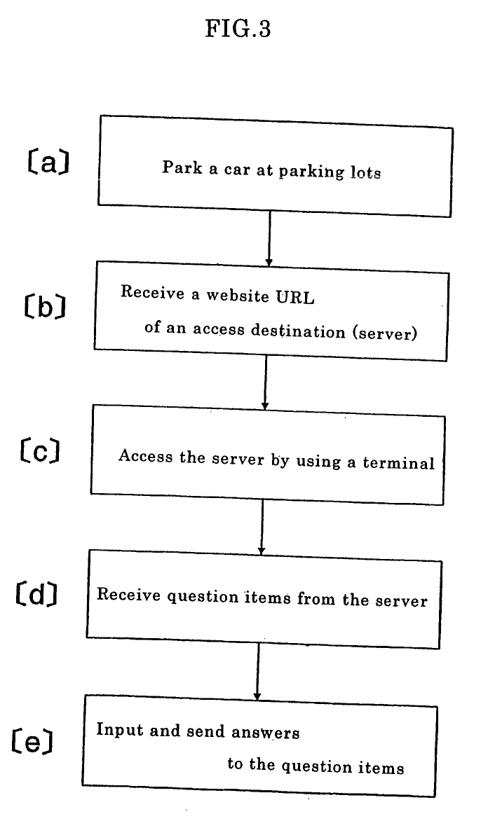

The following description is an example describing how users can use the system. The FIG. 3 shows steps how a user receives benefits at a parking lot.

First, a user parks his/her car at the parking lot (FIG. 3[a]). The parking lot may be either with or without parking attendants. In the parking lot with parking attendants, they may be arranged at the gate to open/close the gate and to give a parking ticket to users. On the other hand, the parking lot without parking attendants is provided with gates or vehicle lock apparatus so that users can park their car for a certain period of time by putting money into a fee collection machine equipped in the parking lot

Next, the user is provided with an access destination (FIG. 3[b]). In this embodiment, the access destination is a website which is administered by the server 9 and the user is provided with the website URL (Uniform Resource Locator) like ┌http://xxx.xx.xx┘ by the means of providing the access destination.

A ticket-vending machine placed at the gate of the parking lot, for example, can be used as the means of providing the access destination In this case, the URL of the access destination is printed on the ticket issued by the ticket-vending machine. Signboards placed in the parking lot can be also used as the means of providing the access destintion. In this case, the URL of the access destination is indicated on the signboards.

The access destination can be provided to the user through a person. For example, an attendant for collecting parking fees is arranged at the gate of the parking lot so that the attendant can provide the user with coupons on which the URL of the access destination is written at the time of making the payment.

The user accesses the website at the URL which is provided by the means of providing the access destination by using the terminal 1 (FIG. 3[c]). A cellular phone of the user may be used as the terminal 1.

If the user has not registered yet, registration procedures will be displayed on the screen. If the user has already registered or if the system is programmed to deal with the registration procedures at the same time of providing the first question, the question items 2 will be displayed on the screen.

Once the question items 2 is displayed on the screen, the appropriate question items 2 are transmitted from the server 9 to the terminal 1 (FIG. 3[d]). The question items 2 may include, for example, “What is the type of your vehicle?”, “When was the vehicle inspection certificate issued?” “Do you have any auto insurance?”, “When will the insurance be expired?” and so on. The contents of the question items 2 are not limited thereto, and they can include other various questions. By asking the above question items 2, the useful answer data 3 relating to use of a vehicle inspection service or purchase of insurance goods can be obtained.

The user inputs and transits the answers to the question items 2 with the buttons or the like of the terminal 1 (FIG. 3[e]). The answers may be transmitted by the Web or Email.

The question items 2 are appropriately selected from the database of the question items 2 which is stored in the server 9 prior to being transmitted. The question items 2 can be selected based on the answer data 3 that the user transmitted in the past. For example, the appropriate question items 2 are selected by extracting keywords such as age, occupation, the purchased goods from the answer data 3 of the past and conducting a search of the database of the question items 2 based on these keywords.

When the user transmits the answer data 3, the information 5 on offering benefits is recorded in the user data 4 which is stored in the server 9, as mentioned before. If the parking lot is of a pay-later type for the parking fees, the user can take advantage of the benefits at the time of paying the parking fees. If the parking fees must be paid first, the user can take advantage of the benefits at the next time of visiting me paring lot.

The user can also take advantage of benefits at places besides the parking lot, such as stores of business providers participating in this system, where goods and services are provided, by going through the similar steps as mentioned above at the time of receiving the goods and services from the business providers.

If one of the business providers participating in the administration of the system manages parking lots, users become willingly to use that particular parking lots so as to receive the benefits or take advantage of the benefits (coupons or the like) the users have received from other business providers at the time of purchasing the goods or services. Therefore, the reduction of the illegal parking can be expected. Furthermore, since users are motivated to choose the parking lot participating in the administration of the system, the parking lot can get a higher utilization rate than other parking lots not participating in the administration of the system.

1. An information collection system comprising:
a means of providing a user with an access destination which is accessible through a terminal of the user,
a means of transmitting question items to the terminal of the user when the user makes an access; and
a means of receiving answer data to the question items transmitted from the terminal of the user.

2. The information collection system according to claim 1, wherein the means of transmitting the question items to the terminal of the user transmits the question items which are appropriately selected based on the answer data that the user transmitted in the past

3. The information collection system according to any one of claim 1 and claim 2 further comprising a means of storing user data, wherein information on offering benefits is recorded in the user data either unconditionally or conditionally when the answer data to the question items is received from the user, so that the benefits for purchasing or using goods or services of appropriate business providers can be given to the user based on the information on offering benefits.

4. The information collection system according to claim 3, wherein the benefits which are given to the user based on the information on offering benefits pertain to use of parking lots.

5. The information collection system according to claim 3, wherein the benefits which are given to the user based on the information on offering benefits pertain to purchase or use of goods or services that various kinds of business providers are offering.

6. The information collection system according to claim 3, further comprising a means of transmitting authentication information to a portable terminal of the user, wherein the authentication information can be outputted in an appropriate form by the portable terminal, so that the authentication information can be used either at a time of placing an order or at a time of making a payment for the purchase or the use of the goods or the services.

7. The information collection system according to claim 4, further comprising a means of transmitting authentication information to a portable terminal of the user, wherein the authentication information can be outputted in an appropriate form by the portable terminal, so that the authentication information can be used either at a time of placing an order or at a time of making a payment for the purchase or the use of the goods or the services.

8. The information collection system according to claim 5, further comprising a means of transmitting authentication information to a portable terminal of the user, wherein the authentication information can be outputted in an appropriate form by the portable terminal, so that the authentication information can be used either at a time of placing an order or at a time of making a payment for the purchase or the use of the goods or the services.
